(19) United States
(12) Patent Application Publication
(10) Pub. No.: US 2026/0095234 A1
(43) Pub. Date: Apr. 2, 2026

(54) METHODS, APPARATUS AND SYSTEMS FOR QCL SWITCHING

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/410,119

(22) Filed: Dec. 5, 2025

Related U.S. Application Data
(63) Continuation of application No. PCT/CN2023/099006, filed on Jun. 7, 2023.

(51) Int. Cl. H04B 7/06; H04W 72/231; H04W 76/20; H04W 84/06

(52) U.S. Cl. CPC H04B 7/06968; H04W 72/231; H04W 76/20; H04W 84/06

(57) ABSTRACT

After carrying out, for a first duration, a first beam activity cycle monitoring for at least one physical downlink control channel (PDCCH) message on a first link using a first QCL assumption type, a user equipment (UE) may perform a QCL switching operation to a second beam activity cycle monitoring for at least one PDCCH message on a second link using a second QCL assumption type. The beam activity cycle durations may be represented in information elements referenced in a TCI/QCL framework, with additional fields. Similarly, the beam activity cycle QCL assumption types may also be represented in information elements referenced in the TCI/QCL framework.

### CROSS-REFERENCE TO RELATED APPLICATION

This application is a continuation of PCT Application No. PCT/CN2023/099006, filed on Jun. 7, 2023, which application is hereby incorporated herein by reference in its entirety

### TECHNICAL FIELD

The present disclosure relates, generally, to wireless communication and, in particular embodiments, to switching from using one quasi co-location assumption type to using another quasi co-location assumption type to monitor for messages.

### BACKGROUND

In traditional cellular wireless communication systems, such as fourth generation (4G) Long Term Evolution (LTE) or fifth generation (5G) New Radio (NR), an element of a network may configure Transmission Configuration Indicator (TCI) states at a user equipment (UE) using so-called higher-layer signaling (e.g., radio resource control, “RRC”). The element may activate TCI states at the UE using so-called lower-layer signaling (e.g., using a media access control-control element, “MAC-CE”). The element may indicate TCI states to use for physical downlink scheduling channel (PDSCH) detection and decoding using dynamic signaling (e.g., downlink control indication, “DCI”). DCI formats may use n bits in a TCI field, where n is selected from among {1,2,3,4}, based on a number of active TCI states. TCI states include a quasi-colocation (QCL) information block. The QCL information block may indicate a source reference signal and a QCL assumption type, which may be any one of TypeA, TypeB, TypeC and TypeD.

In 5G NR Rel-16, enhancements were added in an attempt to realize the potential of mmWave communications. Such enhancements included a time duration for QCL application. When the DCI format includes a TCI state indication, a corresponding time duration for QCL application is provided to the UE to, thereby, allow the UE to switch a beam towards detection and decoding of the PDSCH. This time duration for QCL application starts from a last Orthogonal Frequency Division Multiplexing (OFDM) symbol of a scheduling physical downlink control channel (PDCCH) and ends at a first OFDM symbol of a corresponding PDSCH. This time duration for QCL application is typically configured on a basis of UE capability.

In 5G NR Rel-17, further enhancements were added in conjunction with an introduction of a unified TCI framework. The unified TCI framework allowed a TCI state design to be applicable beyond DL communications (e.g., for PDSCH detection and decoding). The unified TCI framework also allowed the TCI state design to include neighbor cell physical cell identities (PCIs) for Inter-cell Beam Management. A Beam Application Time was also introduced. It may be considered that the Beam Application Time provides the UE with a time to apply the indicated beam for the unified TCI state. Typically, the Beam Application Time is configured on a basis of UE Capability.

### SUMMARY

Through implementation of an improved TCI/QCL framework, with additional fields, QCL switching operations may be rendered less frequent, more predictable, more reliable and illustrative of better integration between terrestrial and non-terrestrial networks. Indeed, after carrying out, for a first duration, a first beam activity cycle monitoring for at least one PDCCH message on a first link using a first QCL assumption type, a UE may perform a QCL switching operation to a second beam activity cycle monitoring for at least one PDCCH message on a second link using a second QCL assumption type. The beam activity cycle durations may be represented in information elements referenced in the improved TCI/QCL framework. Similarly, the beam activity cycle QCL assumption types may also be represented in information elements referenced in the improved TCI/QCL framework.

Existing TCI/QCL frameworks are known to rely upon associating individual beams with source reference signals to perform detection and decoding of PDCCH/PDSCH messages. For example, the TCI/QCL framework defined in 5G defines TCI states such that the defined TCI states correspond to individual receiver beams. As an example, different receiver beams at the UE may be shown to have a specific Azimuth/Zenith angle of arrival. The specific angle of arrival may be shown to correspond to a direction from which the UE is receiving transmissions made using a transmitter beam at a non-terrestrial transmit and receive point (NT-TRP). The direction from which the UE is receiving transmissions may be shown to have a specific Azimuth/Zenith angle of departure. Existing frameworks are known to result in unnecessary signaling overhead, in terms of beam switching between terrestrial network (TN) nodes and non-terrestrial network (NTN) nodes.

Existing types of joint TN/NTN scenarios are known to be associated with relatively long propagation delays and other practical constraints that are familiar from NTN-only scenarios. In the existing types of joint TN/NTN scenarios, the level of integration between terrestrial networks and non-terrestrial networks may be relatively loose or slow. These levels of integration information between TN nodes and NTN nodes may happen on a relatively slow basis, e.g., in the order of 10s, 100s or 1000s of milli-seconds. While tighter integration between terrestrial networks and non-terrestrial networks is certainly possible, such tighter integration may be shown to come at the expense of relatively high protocol complexity and relatively high equipment complexity.

Wireless communications networks are known to have coverage holes. Depending on the scenario and the nature of the deployment, coverage holes can be created by buildings, tunnels and, even, advertisement billboards. Such lapses in the coverage provided by a wireless communications network are known to cause connection droppings resulting in a perception, at the user of the UE, of poor coverage.

Through the implementation of an improved TCI/QCL framework representative of aspects of the present application, a reduction may be realized in a frequency of beam switching from a terrestrial wireless link to a non-terrestrial wireless link and back again. Indeed, upon implementation of an improved TCI/QCL framework representative of aspects of the present application, terrestrial networks and non-terrestrial networks may be perceived as being better integrated and more reliable wireless signal coverage may be experienced.

According to an aspect of the present disclosure, there is provided a method. The method includes monitoring, using a first quasi-colocation (QCL) assumption type, for at least one physical downlink control channel (PDCCH) message on a first link, wherein the first link is one of a terrestrial network (TN) link and a non-terrestrial network (NTN) link and responsive to expiry of a predetermined duration of time associated with the first QCL assumption type, switching to monitor, using a second QCL assumption type, for at least one PDCCH message on a second link, wherein the second link is the other one of a terrestrial network (TN) link and a non-terrestrial network (NTN) link.

In one possible implementation of the above aspect, the method further comprising receiving a TN NTN Transmission Configuration Indicator (TCI) state information element (IE), wherein the TN NTN TCI state IE indicates that a first IE indicates the duration of time.

In one possible implementation of the above aspect, the method further comprising receiving downlink control information (DCI) signaling, the DCI signaling indicates the duration of time.

In one possible implementation of the above aspect, the method further comprising receiving radio resource control (RRC) signaling, the RRC signaling including an indication of the duration of time.

According to an aspect of the present disclosure, there is provided an apparatus. The apparatus includes at least one processor coupled to a memory storing computer-readable instructions, caused, by executing the computer-readable instructions, to monitor, using a first quasi-colocation (QCL) assumption type, for at least one physical downlink control channel (PDCCH) message on a first link, wherein the first link is one of a terrestrial network (TN) link and a non-terrestrial network (NTN) link and switch, responsive to expiry of a duration of time associated with the first QCL assumption type, to monitor, using a second QCL assumption type, for at least one PDCCH message on a second link, wherein the second link is the other one of the TN link and the NTN link.

According to an aspect of the present disclosure, there is provided a non-transitory computer-readable medium storing instructions. The instructions, when executed by a processor, may cause the processor to monitor, using a first quasi-colocation (QCL) assumption type, for at least one physical downlink control channel (PDCCH) message on a first link, wherein the first link is one of a terrestrial network (TN) link and a non-terrestrial network (NTN) link and switch, responsive to expiry of a duration of time associated with the first QCL assumption type, to monitor, using a second QCL assumption type, for at least one PDCCH message on a second link, wherein the second link is the other one of the TN link and the NTN link.

According to an aspect of the present disclosure, there is provided a method. The method includes implementing a first beam activity cycle, where the first beam activity cycle includes monitoring for at least one physical downlink control channel (PDCCH) message on a first link using a first quasi-colocation (QCL) assumption type and responsive to having detected no PDCCH messages for a predetermined consecutive number of time slots, switching to implement a second beam activity cycle, where the second beam activity cycle includes monitoring for PDCCH messages on a second link using a second QCL assumption type.

According to an aspect of the present disclosure, there is provided an apparatus. The apparatus includes at least one processor coupled to a memory storing computer-readable instructions, caused, by executing the computer-readable instructions, to implement a first beam activity cycle, where the first beam activity cycle includes monitoring for at least one physical downlink control channel (PDCCH) message on a first link using a first quasi-colocation (QCL) assumption type and switch, responsive to having detected no PDCCH message for a predetermined consecutive number of time slots, to implement a second beam activity cycle, where the second beam activity cycle includes monitoring for at least one PDCCH message on a second link using a second QCL assumption type.

According to an aspect of the present disclosure, there is provided a non-transitory computer-readable medium storing instructions. The instructions, when executed by a processor, may cause the processor to implement a first beam activity cycle, where the first beam activity cycle includes monitoring for at least one physical downlink control channel (PDCCH) message on a first link using a first quasi-colocation (QCL) assumption type and switch, responsive to having detected no PDCCH message for a predetermined consecutive number of time slots, to implement a second beam activity cycle, where the second beam activity cycle includes monitoring for at least one PDCCH message on a second link using a second QCL assumption type.

According to an aspect of the present disclosure, there is provided a method. The method includes implementing a first beam activity cycle, where the first beam activity cycle includes monitoring for physical downlink control channel (PDCCH) messages on a first link using a first quasi-colocation (QCL) assumption type and responsive to having detected a PDCCH message that includes dynamic QCL switching indication, the dynamic QCL switching indication second QCL assumption type and a duration, switching to implement a second beam activity cycle, where the second beam activity cycle includes monitoring for PDCCH messages on a second link using the second QCL assumption type.

According to an aspect of the present disclosure, there is provided an apparatus. The apparatus includes at least one processor coupled to a memory storing computer-readable instructions, caused, by executing the computer-readable instructions, to implement a first beam activity cycle, where the first beam activity cycle includes monitoring for at least one physical downlink control channel (PDCCH) message on a first link using a first quasi-colocation (QCL) assumption type and switch, to having detected a PDCCH message that includes a dynamic QCL switching indication, the dynamic QCL switching indication including a second QCL assumption type and a duration, to implement a second beam activity cycle, where the second beam activity cycle includes monitoring for at least one PDCCH message on a second link using the second QCL assumption type.

According to an aspect of the present disclosure, there is provided a non-transitory computer-readable medium storing instructions. The instructions, when executed by a processor, may cause the processor to implement a first beam activity cycle, where the first beam activity cycle includes monitoring for at least one physical downlink control channel (PDCCH) message on a first link using a first quasi-colocation (QCL) assumption type and switch, to having detected a PDCCH message that includes a dynamic QCL switching indication, the dynamic QCL switching indication including a second QCL assumption type and a duration, to implement a second beam activity cycle, where the second beam activity cycle includes monitoring for at least one PDCCH message on a second link using the second QCL assumption type.

According to an aspect of the present disclosure, there is provided a system. The system includes a first apparatus, a second apparatus and a third apparatus. The first apparatus is operable to transmit at least one physical downlink control channel (PDCCH) message on a first link, wherein the first link is one of a terrestrial network (TN) link and a non-terrestrial network (NTN) link. The second apparatus is operable to transmit at least one PDCCH message on a second link, wherein the second link is the other one of the TN link and the NTN link. The third apparatus includes at least one processor coupled to a memory storing computer-readable instructions, caused, by executing the computer-readable instructions, to monitor, using a first quasi-colocation (QCL) assumption type, for the at least one PDCCH message on the first link and switch, responsive to expiry of a duration of time associated with the first QCL assumption type, to monitor, using a second QCL assumption type, for the at least one PDCCH message on the second link.

In one possible implementation of any one of above aspects or implementations, the first QCL assumption type is a TN-specific QCL assumption type and the second QCL assumption type is an NTN-specific QCL assumption type. Or, the first QCL assumption type is an NTN-specific QCL assumption type and the second QCL assumption type is a TN-specific QCL assumption type.

In one possible implementation of any one of above aspects or implementations, the first QCL assumption type comprises at least one of a spatial receive filter or an average delay.

In one possible implementation of any one of above aspects or implementations, the duration of time is expressed in: milli-seconds; orthogonal frequency-division multiplexing (OFDM) symbols; groups of OFDM symbols; mini-slots; groups of mini-slots; slots; groups of slots; seconds; micro-seconds; or nano-seconds.

In one possible implementation of any one of above aspects or implementations, the TN NTN TCI state IE indicates that a second IE indicates the first QCL assumption type. The TN NTN TCI state IE may an indication of a further IE that includes an indication of a duration for an inactivity timer, thereby providing a duration for a time interval for which the first QCL assumption type is not used to monitor for PDCCH messages on the first link.

According to an aspect of the present disclosure, there is provided a computer program comprising instructions. The instructions, when executed by a processor, may cause the processor to implement the method of any one of any one of above aspects or implementations.

According to an aspect of the present disclosure, there is provided a non-transitory computer-readable medium storing instructions, the instructions, when executed by a processor, may cause the processor to implement the method of any one of any one of above aspects or implementations.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a user equipment in a terrestrial wireless communication network coverage hole;

FIG. 7 illustrates the user equipment of FIG. 6 in the same terrestrial wireless communication network coverage hole, where the arrangement of FIG. 7 differs from the arrangement of FIG. 6 in that the user equipment of FIG. 7 is allowed to maintain a connection with a wireless communication network via a connection to an non-terrestrial transmit receive point, in accordance with aspects of the present application;

FIG. 8 illustrates an example terrestrial network non-terrestrial network Transmission Configuration Indicator (NT NTN TCI) state, in accordance with aspects of the present application;

FIG. 9 illustrates a time diagram for a first scheme, in accordance with aspects of the present application;

FIG. 10 illustrates example steps in a method, in accordance with aspects of the present application;

FIG. 11 illustrates a time diagram for a second scheme, in accordance with aspects of the present application;

FIG. 12 illustrates an example TN NTN TCI state IE, in accordance with aspects of the present application;

FIG. 13 illustrates an example TN NTN TCI state IE, in accordance with aspects of the present application; and

FIG. 14 illustrates an example new downlink control information format, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

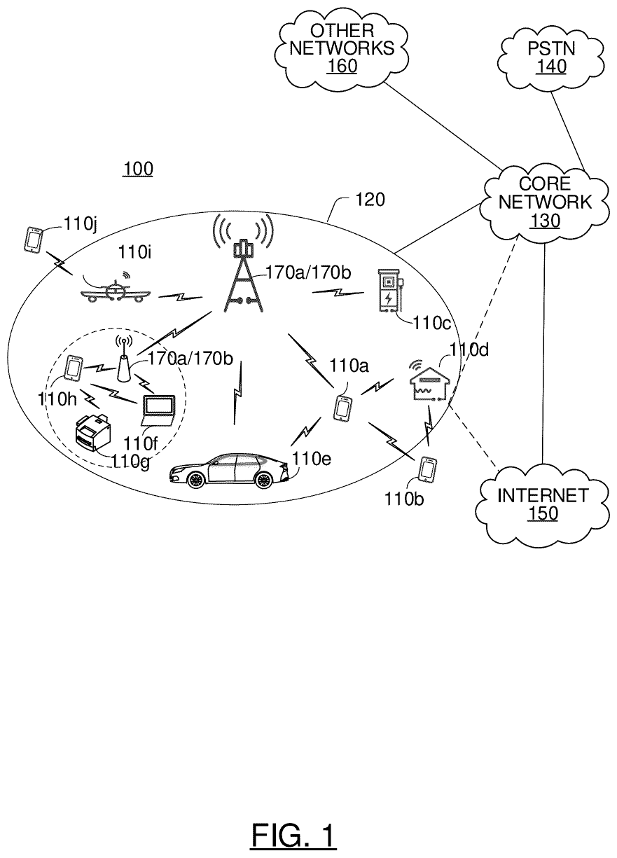

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another and/or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

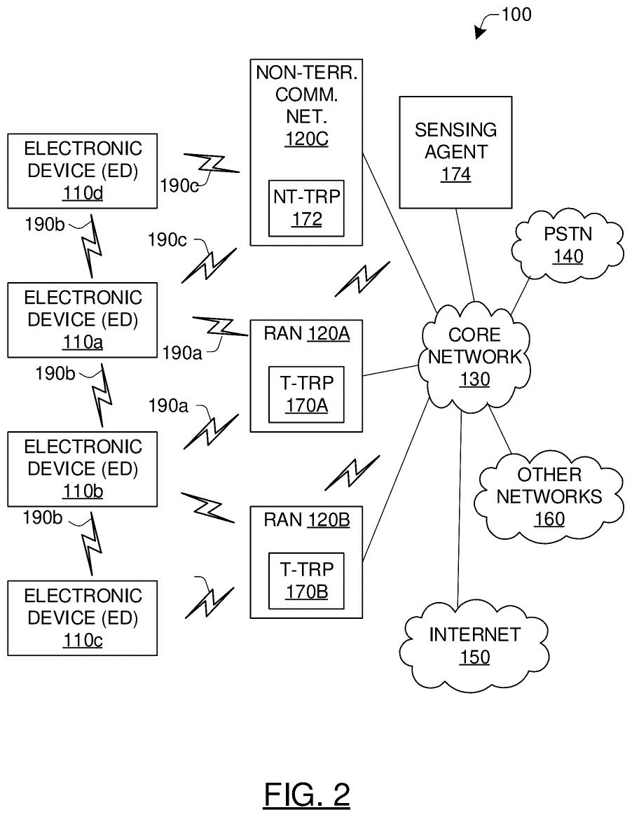

FIG. 2 illustrates an example communication system 100. In general, the communication system 100 enables multiple wireless or wired elements to communicate information. The purpose of the communication system 100 may be to provide information, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. The non-terrestrial communication network 120c may include at least one non-terrestrial network device and at least one corresponding terrestrial network device, wherein the at least one non-terrestrial network device works as a transport layer device and the at least one corresponding terrestrial network device works as a radio access network node, which communicates with the ED via the non-terrestrial network device.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

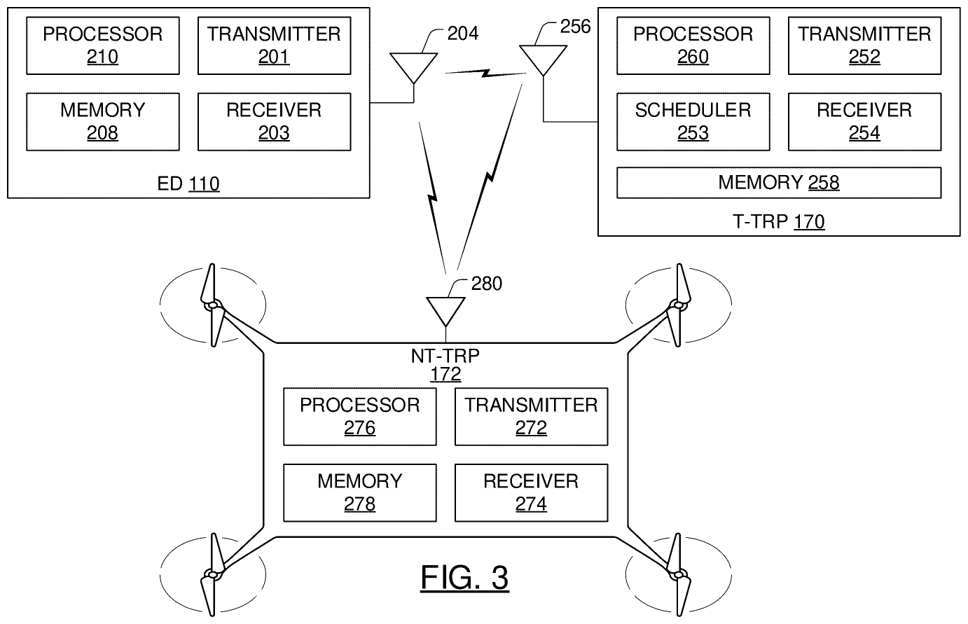

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (e.g., established, activated or enabled), turned-off (e.g., released, deactivated or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 may include at least one memory 208. The memory 208 stores instructions and/or data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources.

The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

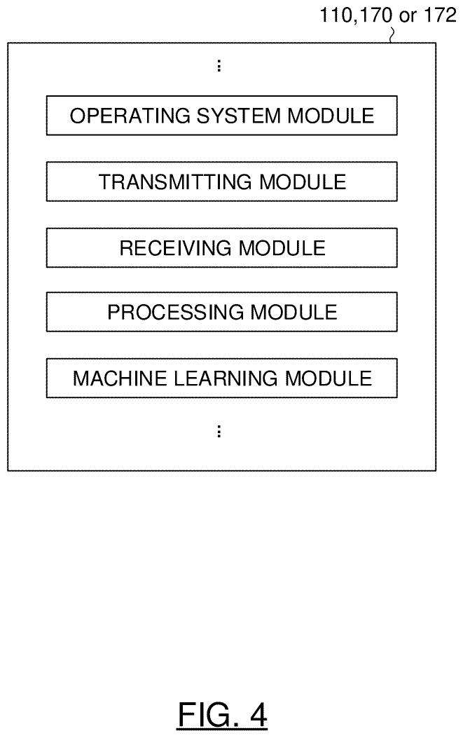

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, e.g., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common (or group) control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The above mentioned configuration parameters may be signaled via, but not limited to, radio resource control (RRC) layer signaling, media access control (MAC) layer signaling, physical layer signaling (e.g., downlink control information) or any combination.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency of the carrier, the lowest frequency of the carrier, the highest frequency of the carrier or a reference point that is outside the carrier and an offset. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 in FIG. 2 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

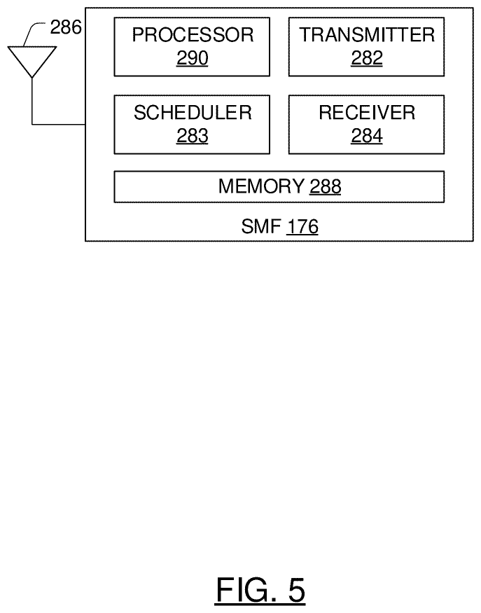

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing-based technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common PDCCH and a common PUCCH may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f-f_{chirp0}=α(t-t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}-f_{chirp0} and the time duration of the linear chirp signal may be defined as T=t_{chirp1}-t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a synchronization signal block (SSB) resource identifier, or a sounding reference signal (SRS) resource identifier, or other reference signal resource identifier.

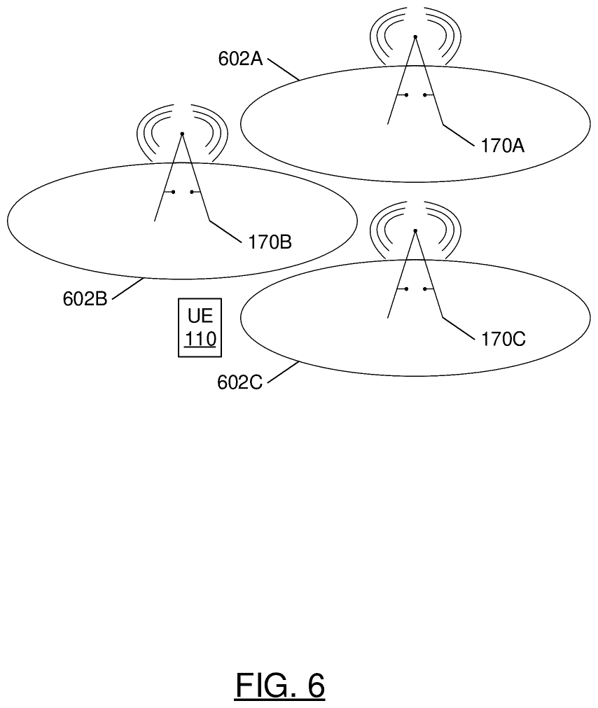

In a scenario in which a UE 110 has completed an Initial Access procedure with a T-TRP 170, the UE 110 may be understood to be in communication with all of the T-TRPs 170 that are part of the RAN to which the UE 110 is connected. However, due to the nature of the deployment, predictably changing radio conditions, randomly changing radio conditions, obstacles in the environment and other such factors, the UE 110 may find itself in a “coverage hole.” A coverage hole may be defined as a region in which the UE 110 is no longer able to communicate with a T-TRP. FIG. 6 illustrates a UE 110 in a wireless communication network coverage hole. Indeed, the UE 110 is not in a first coverage area 602A provided by a first T-TRP 170A, a second coverage area 602B provided by a second T-TRP 170B or a third coverage area 602C provided by a third T-TRP 170C.

It may be shown that, upon arriving in a coverage hole, the UE 110 may no longer be able to decode PDCCHs transmitted by T-TRPs 170. Consequently, the UE 110 is disconnected from a network with which the UE 110 was previously connected.

It may be considered that T-TRPs 170 provide on-the-ground-based coverage to UEs 110. Conversely, it may be considered that NT-TRPs 172 provide non-terrestrial coverage to UEs 110. Examples of NT-TRPs 172 include a satellite, a high-altitude platform system (HAPS), a balloon, an unmanned aerial vehicle (UAV) and a drone. It is known that NT-TRPs 172 may provide, to UEs 110 on the ground, coverage that extends over an area that is much wider ranging than the extent of the area of the coverage typically provided by a T-TRP 170. To accomplish this much wider coverage area, the NT-TRPs 172 are known to take advantage of their altitude. However, it may be shown that the much wider coverage area comes with drawbacks that lead to poorer received signal quality. The poorer received signal quality may be understood to be due to a greater free-space path loss, relative to free-space path loss associated with received signal quality from a T-TRP 170. The poorer received signal quality may also be understood to be due to other atmospheric losses, such as ionospheric scintillating losses, which are typically not present in signals received from a T-TRP 170. Nevertheless, it may be shown that these drawbacks can be overcome, at the NT-TRPs 172, through the application of proper link budgeting and through the leveraging of massive multiple input multiple output (MIMO) techniques.

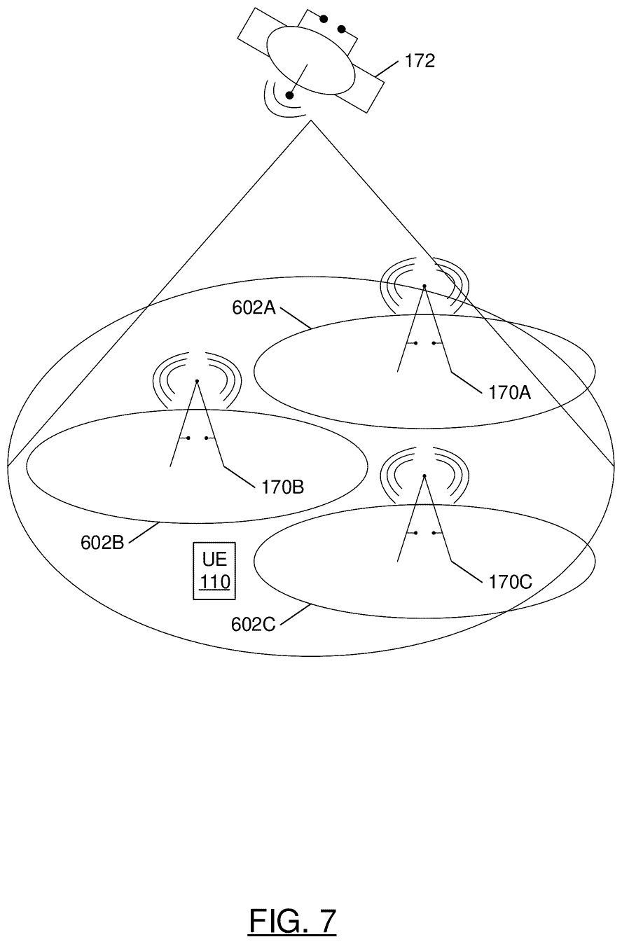

FIG. 7 illustrates the UE 110 of FIG. 6 in the same terrestrial coverage hole. The arrangement of FIG. 7 differs from the arrangement of FIG. 6 in that the UE 110 is allowed to maintain a connection with a network via a connection to an NT-TRP 172. That is, it may be shown that, upon arriving in a terrestrial coverage hole, the UE 110 may switch from decoding PDCCHs transmitted by T-TRPs 170 to decoding PDCCHs transmitted by the NT-TRPs 172. Consequently, the UE 110 is permitted to maintain connection with network with which the UE 110 was connected via the T-TRPs 170. Aspects of the present application relate to allowing a given UE 110 to connect to either a T-TRP 170 or an NT-TRP 172.

Some aspects of the present application relate to loosely integrated terrestrial and non-terrestrial systems. In the context of the present application, terrestrial and non-terrestrial systems are considered to be loosely integrated when the terrestrial and non-terrestrial systems are using the same air interface (e.g., using the same frame structure, time/frequency resource definitions, etc.) and the same medium access control (MAC) layer, but the timing boundaries of frames and/or slots are misaligned by more than the cyclic prefix (CP) length and the frequency of any message exchanges occurring between the MAC layer of the terrestrial and non-terrestrial systems is in the order of tens of milli-seconds or more than tens of milli-seconds. Similarly, terrestrial and non-terrestrial systems are considered to be tightly integrated when the terrestrial and non-terrestrial systems are using the same air interface (e.g., using the same frame structure, time/frequency resource definitions, etc.) and the same MAC layer, and the timing boundaries of frames and/or slots are misaligned by less than the CP length and the frequency of any message exchanges occurring between the MAC layer of the terrestrial and non-terrestrial systems is in the order of one milli-second or less than one milli-second. More specifically, aspects of the present application relate to a method of switching based on using a defined “Beam Activity Cycle.” The Beam Activity Cycle specifies a time interval during which a given UE 110 is to use a first QCL assumption type (e.g., QCL Type D, which defines a spatial Rx filter) when monitoring for at least one PDCCH message on a first link (e.g., a TN link or an NTN link). Once the time interval has expired, the given UE 110 may carry out a switching operation to proceed to use a second QCL assumption type when monitoring for at least one PDCCH message on a second link.

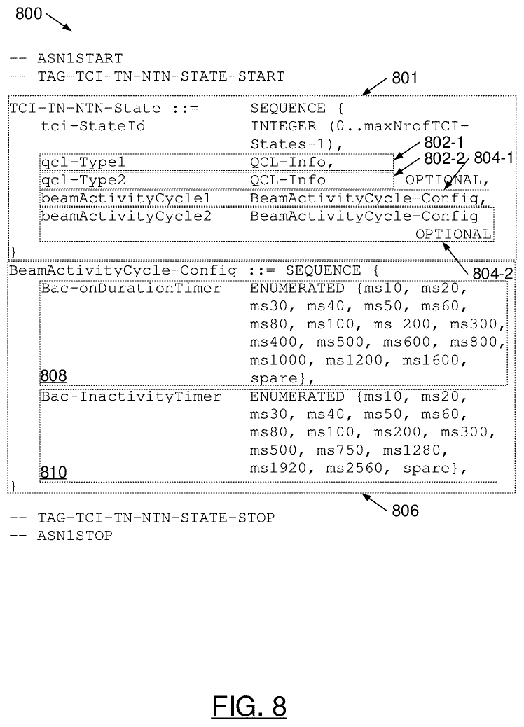

FIG. 8 illustrates an example TN NTN TCI state 800. The example TN NTN TCI state 800 illustrated in FIG. 8 includes a TN NTN TCI state IE 801. The TN NTN TCI state IE 801 includes two QCL-Info fields, denoted as a qcl-Type1 field 802-1 and a qcl-Type2 field 802-2, and two BeamActivityCycle-Config fields, denoted as a beamActivityCycle1 field 804-1 and a beamActivityCycle2 field 804-2. For the example presented in FIG. 8, it may be assumed that the qcl-Type1 field 802-1 is associated with the beamActivityCycle1 field 804-1. This association may be understood to form a QCL relationship for an NTN link. Similarly, it may be assumed that the qcl-Type2 field 802-2 is associated with the beamActivityCycle2 field 804-2 and that this association forms a QCL relationship for a TN link. Other association mechanisms between the QCL assumption and the Beam Activity Cycle can be implemented. In a first example: the BeamActivityCycle-Config IE may include a beamActivityCycleIdentity field, in which may be found a positive integer value and the QCL-Info field may include also include a beamActivityCycleIdentity field, the qcl-Type1 field 802-1 (resp. qcl-Type2 field 802-2) is associated with the BeamActivityCycle-Config IE whose beamActivityCycleIdentity field has the same value as the beamActivityCycleIdentity field in qcl-Type1 field 802-1 (resp. qcl-Type2 field 802-2). In a second example: the qcl-Type1 field 802-1 (resp. qcl-Type2 field 802-2) may include the BeamActivityCycle-Config IE, the qcl-Type1 field 802-1 (resp. qcl-Type2 field 802-2) is associated with the BeamActivityCycle-Config IE that qcl-Type1 field 802-1 includes (resp. qcl-Type2 field 802-2).

The example TN NTN TCI state IE 801 illustrated in FIG. 8 includes a BeamActivityCycle-Config IE 806 referenced in the beamActivityCycle1 field 804-1 and the beamActivityCycle2 field 804-2. The BeamActivityCycle-Config IE 806 contains a field denoted as a bac-onDurationTimer field 808. In use, the bac-onDurationTimer field 808 may be understood to provide a time interval for which an associated QCL assumption type, determined on the basis of a value in the qcl-Type1 field 802-1, is to be active and is to be used by the UE 110 when monitoring for at least one PDCCH message on the corresponding link (e.g., the NTN link). In the example presented in FIG. 8, the time interval value in the bac-onDurationTimer field 808 is provided in milli-seconds. However, it should be clear that other units may be considered. Examples of other units available for consideration include OFDM symbols, groups of OFDM symbols, mini-slots, groups of mini-slots, slots, groups of slots, seconds, micro-seconds and nano-seconds. Similarly, the BeamActivityCycle-Config IE 806 may include a field denoted as bac-InactivityTimer field 810. The bac-InactivityTimer field 810 may be understood to provide a time interval for which an associated QCL assumption type, determined on the basis of a value in the qcl-Type1 field 802-1, is inactive and is not used by the UE 110 to monitor for at least one PDCCH message on the corresponding link (e.g., the NTN link).

Throughout the present application, it is assumed that a radio frame (or simply a “frame”) has a given quantity of subframes (e.g., a given frame may have 10 subframes). Each subframe have a given quantity of slots (e.g., a given subframe may have a single slot). Each frame has a corresponding System Frame Number (SFN). SFNs for a given set of frames may extend between, e.g., 0 and 1023. Other example configurations of radio frames, subframes, slots and system frame numbers have been contemplated.

In preceding paragraphs, discussion of the BeamActivityCycle-Config IE 806 of FIG. 8 includes discussion of the bac-onDurationTimer field 808 and the bac-InactivityTimer field 810. Although not explicitly stated, the bac-onDurationTimer field 808 and the bac-InactivityTimer field 810 relate to a Beam Activity Cycle timer (not explicitly shown) and a Beam Inactivity Cycle timer (not explicitly shown), respectively. The paragraphs below discuss example embodiments of the manner in which the Beam Activity Cycle timer and the Beam Inactivity Cycle timer may be interpreted and implemented.

The bac-onDurationTimer field 808 may be applied such that the Beam Activity Cycle timer starts running from the first OFDM symbol of the first slot of the first frame following receipt of the frame with the higher-layer signaling message (e.g., RRC signaling message) carrying the bac-onDurationTimer field 808. The value received in the bac-onDurationTimer field 808 may be understood as a time interval or a duration of time for which the QCL assumption of the corresponding link is applied. Taking 10 milli-seconds as an example for the duration of the beam activity cycle and 1 milli-second for the duration of a slot, starting from the first OFDM symbol of the first slot where the Beam Activity Cycle timer is applied, the UE 110 starts the Beam Activity Cycle timer and this timer runs for 10 milli-seconds. During this time the UE 110 applies the QCL assumption of the corresponding link to detect and decode any transmissions on a physical downlink channel (e.g., control and/or data) as well as to detect and measure any corresponding reference signals (e.g., CSI-RS for Beam Management, CSI-RS for CSI feedback, DM-RS). After 10 milli-seconds, the Beam Activity Cycle timer is said to expire and, responsively, the UE 110 is expected to stop applying the QCL assumption of the corresponding link and, thus, no longer detects or decodes any transmissions on the physical downlink channel of the corresponding link. Similarly, the UE 110 also no longer detects and measures any corresponding reference signals on the corresponding link.

As an example, starting the Beam Activity Cycle timer may be interpreted as setting the initial value of the Beam Activity Cycle timer to the value received in the bac-onDurationTimer field 808. The Beam Activity Cycle timer running may be interpreted as decrementing the Beam Activity Cycle timer by one milli-second every time a slot passes (assuming that a slot has a duration of one milli-second). The Beam Activity Cycle timer expiring may be interpreted as the Beam Activity Cycle timer reaching the value of zero. In another example, starting the Beam Activity Cycle timer may be interpreted as setting the initial value of the Beam Activity Cycle timer to the value of zero. The Beam Activity Cycle timer running may be interpreted as incrementing the Beam Activity Cycle timer by one milli-second every time a slot passes (assuming that a slot has a duration of one milli-second). The Beam Activity Cycle timer expiring may be interpreted as the Beam Activity Cycle timer reaching the value received in the bac-onDurationTimer field 808.

In other embodiments, the starting time for the Beam Activity Cycle timer may be explicitly configured to the UE 110 using a higher-layer signaling parameter, denoted as, e.g., bac-startingTime (not shown). This higher-layer signaling parameter may indicate a given slot position or index within a frame and the Beam Activity Cycle timer starts running in the current frame if the slot position indicated by bac-startingTime hasn't passed, or the Beam Activity Cycle timer starts running the next frame if the slot position indicated by bac-startingTime has passed already. The bac-startingTime field may be understood as an absolute starting time given, e.g., in hours, minutes, seconds, milli-seconds, etc., relative to a reference time system such as Coordinated Universal Time. The bac-startingTime field may be understood as a relative starting time given, e.g., in milli-seconds relative to the start of a frame.

Variations allow the BeamActivityCycle-Config IE 806 to be expanded to include further fields, e.g., a field (not shown) for holding an indication of a starting time slot associated with the bac-onDurationTimer field 808 and a field (not shown) for holding an indication of a starting time slot associated with the bac-InactivityTimer field 810.

The bac-InactivityTimer field 810 may be applied such that the bac-InactivityTimer starts running from the first OFDM symbol of the first slot following the slot in which the Beam Activity Cycle timer (whose value is set by the bac-on DurationTimer field 808) ends. The value set for the bac-InactivityTimer field 810 may be understood as a time interval or a duration of time for which the QCL assumption of the corresponding link is not applied. Taking 10 milli-seconds as an example for the duration of the beam inactivity cycle and one milli-second for the duration of a slot, starting from the first OFDM symbol of the first slot where the bac-InactivityTimer is applied, the UE 110 starts the Beam Inactivity Cycle timer and this timer runs for 10 milli-seconds. During this time, the UE 110 does not apply the QCL assumption of the corresponding link to detect and decode any transmissions on a physical downlink channel (e.g., control and/or data). As well, the UE 110 does not apply the QCL assumption of the corresponding link to detect and measure any corresponding reference signals (e.g., CSI-RS for Beam Management, CSI-RS for CSI feedback, DM-RS).

As an example, starting the Beam Inactivity Cycle timer may be interpreted as setting the initial value of the Beam Inactivity Cycle timer to the value set in the bac-InactivityTimer field 810. The Beam Inactivity Cycle timer running may be interpreted as decrementing the Beam Inactivity Cycle timer by one milli-second every time a slot passes (assuming that a slot has a duration of one milli-second). The Beam Inactivity Cycle timer expiring may be interpreted as the Beam Inactivity Cycle timer reaching the value of zero. In another example, starting the Beam Inactivity Cycle timer may be interpreted as setting the initial value of the Beam Inactivity Cycle timer to the value of zero. The Beam Inactivity Cycle timer running may be interpreted as incrementing the Beam Inactivity Cycle timer by one milli-second every time a slot passes (assuming that a slot has a duration of one milli-second). The Beam Inactivity Cycle timer expiring may be interpreted as the Beam Inactivity Cycle timer reaching the value set in the bac-InactivityTimer field 810.

In other embodiments, the starting time for the Beam Inactivity Cycle timer may be explicitly configured to the UE 110 using a higher-layer signaling parameter, denoted as, e.g., bac-startingTime (not shown). This higher-layer signaling parameter may indicate a given slot position or index within a frame and the Beam Inactivity Cycle timer starts running in the current frame if the slot position indicated by bac-startingTime hasn't passed, or the Beam Inactivity Cycle timer starts running the next frame if the slot position indicated by bac-startingTime has passed already.

In other embodiments, the starting time for the Beam Inactivity Cycle timer may be explicitly configured to the UE 110 using a higher-layer signaling parameter, denoted as, e.g., bac-startingTime (not shown). This higher-layer signaling parameter may indicate a given slot position or index within a frame and the Beam Inactivity Cycle timer starts running in the current frame if the slot position indicated by bac-startingTime hasn't passed, or the Beam Activity Cycle timer starts running the next frame if the slot position indicated by bac-startingTime has passed already. The bac-startingTime field may be understood as an absolute starting time (given, e.g., in hours, minutes, seconds, milli-seconds, etc., relative to a reference time system, such as Coordinated Universal Time) or a relative starting time (given, e.g., in milli-seconds relative to the start of a frame).

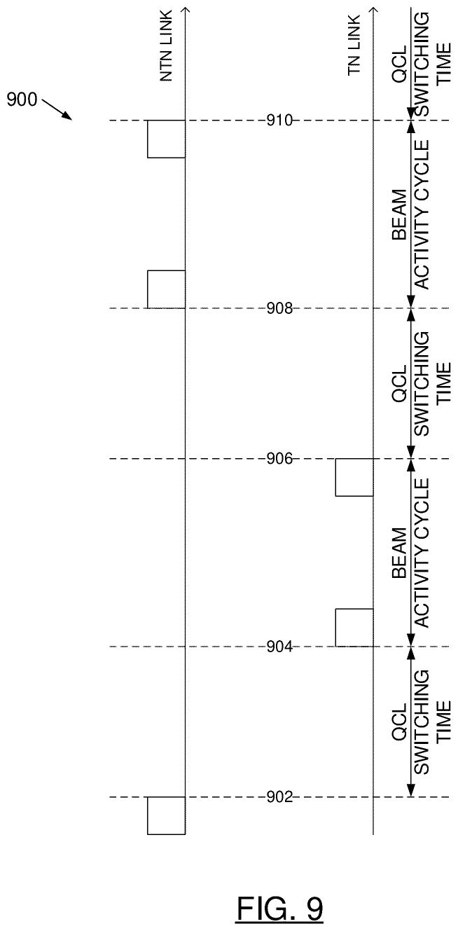

FIG. 9 illustrates a time diagram 900 for a first scheme.

For discussion purposes, it may be assumed that a UE 110 is configured with the TN NTN TCI state 800 of FIG. 8. On the basis of the TN NTN TCI state 800, at the beginning of the time diagram 900 of FIG. 9, the UE 110 may be understood to be monitoring for at least one PDCCH message on a first link using a first QCL assumption type. As illustrated in FIG. 9, the first link is an NTN link.

It may be understood that, at a time preceding the time illustrated in the time diagram 900 of FIG. 9, the UE 110 has connected to an NT-TRP 172 via the NTN link. It may further be understood that the UE 110 has monitored for at least one PDCCH message on the NTN link using a QCL assumption type determined on the basis of a value in the qcl-Type field 802-1. In particular, the qcl-Type1 field 802-1 may, for example, reference a QCL-Info Information Element (IE). The QCL-Info IE (not shown) may include a Qcl-Type field that references a QCL assumption type that specifies properties, e.g., a spatial Rx filter and/or an average delay. As discussed hereinbefore, known QCL assumption types include TypeA, TypeB, TypeC and TypeD. The QCL-Info IE (not shown) may also include a referenceSignal field that specifies one of, for example, a GNSS reference signal, an SS/PBCH block or a non-zero-power (NZP) CSI-RS.

At a first time instance 902, the UE 110 may commence a new beam activity cycle. The new beam activity cycle may be defined to involve use of a QCL assumption type that is distinct from the QCL assumption type used, by the UE 110, for monitoring for at least one PDCCH message on the NTN link. Accordingly, the UE 110 carries out a QCL switching operation. It may be understood that the commencement of a new beam activity cycle may not occur instantaneously. That is, the QCL switching operation may be understood to take a certain duration, which is labeled, in FIG. 9, as “QCL switching time.” The QCL switching time may be defined as a UE capability and may be provided using milli-seconds as the units. However, it should be clear that other units may be considered. Examples of other units available for consideration include OFDM symbols, groups of OFDM symbols, mini-slots, groups of mini-slots, slots, groups of slots, seconds, micro-seconds and nano-seconds.

At a second time instance 904, that is, after the completion of the QCL switching time, the UE 110 may begin monitoring for at least one PDCCH message on a second link using the QCL assumption type configured in the QCL-Info IE (not shown) that is referenced in the qcl-Type1 field 802-2. As illustrated in FIG. 9, the second link is a TN link. The UE 110 may continue monitoring for at least one PDCCH message on the TN link until a third time instance 906, at which time instance the UE 110 may commence a further new beam activity cycle. It may be understood that, at a time preceding the time illustrated in the time diagram 900 of FIG. 9, the UE 110 has connected to a T-TRP 170 via the TN link.

The new beam activity cycle that begins at the first time instance 902 may be understood to have a duration given by a value in the bac-onDurationTimer field 808 in the BeamActivityCycle-Config IE 806 that is referenced in the beamActivityCycle2 field 804-2 of the example TN NTN TCI state IE 801. Notably, the value in the bac-onDurationTimer field 808 specifies a duration from the first time instance 902 to the third time instance 906, including the QCL switching time and the time during which the UE 110 was monitoring for at least one PDCCH message on the TN link.

The further new beam activity cycle may be understood to start from a slot whose starting OFDM symbol is after the end of the value in the bac-onDurationTimer field 808 in the BeamActivityCycle-Config IE 806 that is referenced in the beamActivityCycle2 field 804-2. To begin the further new beam activity cycle, the UE 110 may undertake a QCL switching operation to switch the QCL assumption type that is being used to monitor for PCCDH messages on the TN to the QCL assumption type configured in the QCL-Info IE (not shown) that is referenced in the qcl-Type1 field 802-1.

Starting from the slot whose starting OFDM symbol is after the end of the QCL switching time, that is, at a fourth time instance 908, the UE 110 starts monitoring for at least one PDCCH message on the NTN link using the QCL assumption type configured in the QCL-Info IE (not shown) that is referenced in the qcl-Type1 field 802-1.

At a fifth time instance 910, the UE 110 may determine that a duration of time that is equivalent to the value in the bac-onDurationTimer field 808 in the BeamActivityCycle-Config 1E 806 that is referenced in the beamActivityCycle1 field 804-1 has elapsed, the UE 110 may, once again, switch its QCL assumption type to the QCL assumption type configured in configured in the QCL-Info IE (not shown) that is referenced in the qcl-Type2 field 802-2.

After the fifth time instance 910, the cycle may be shown to repeat in the same manner until the UE 110 goes to sleep, the UE 110 leaves the connected mode or the UE 110 receives some new higher-layer configuration from the NT-TRP 172 regarding TCI states. These aspects of the present application may be shown to allow the UE 110 to periodically switch between different links without requiring the T-TRP 170 or the NT-TRP 172 to explicitly signal or indicate, to the UE 110, a particular link to use at any given time. It may be shown that these aspects of the present application are suitable for scenarios of loosely-coordinated TN/NTN systems where the coordination between the elements of the terrestrial networks and the elements of the non-terrestrial networks is slow (e.g., in the order of tens or hundreds of milli-seconds). It should be noted that, in the context of the present application, “loosely integrated TN/NTN systems” are equivalent referred to as “loosely-coordinated TN/NTN systems.”

Aspects of the present application relate to scenarios in which the bac-InactivityTimer field 810 is provided with a value. In the following example, the time interval value provided the bac-InactivityTimer field 810 is expressed in milli-seconds. Notably, however, other units may be considered, as has been discussed hereinbefore.

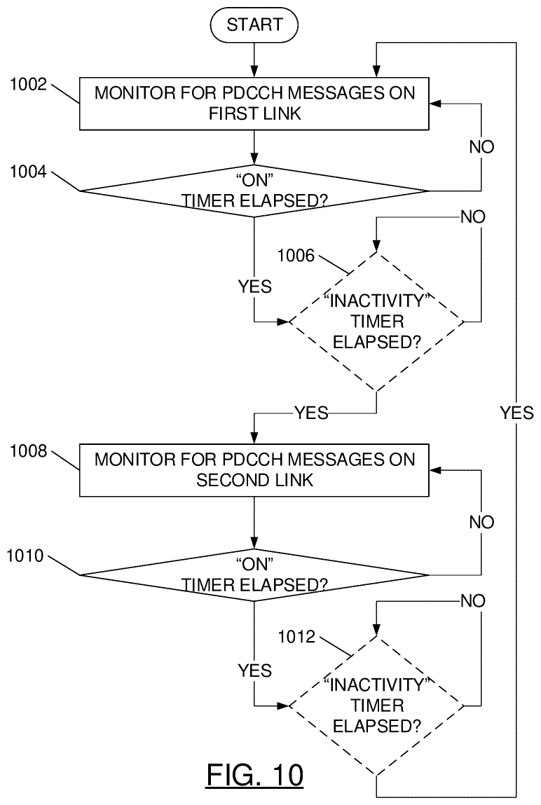

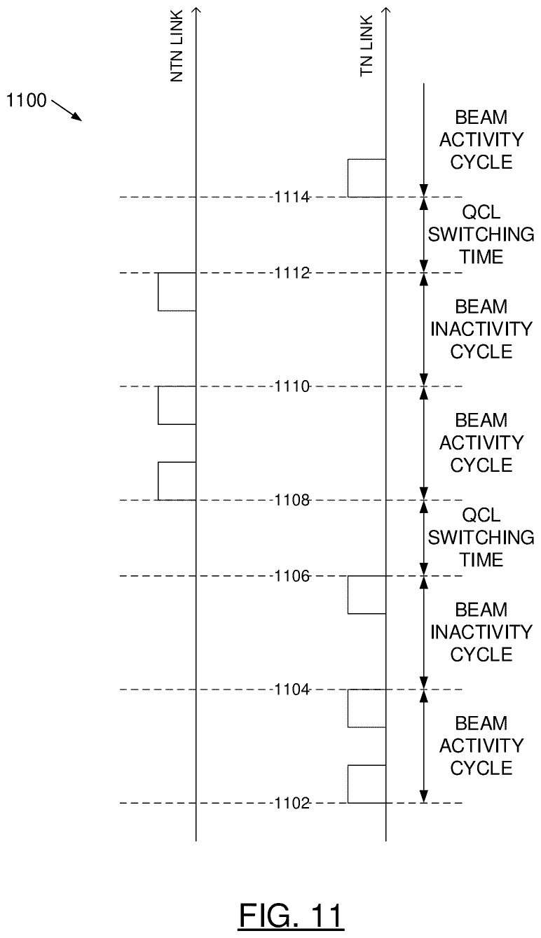

When a UE 110 is configured with a TN NTN TCI state that includes the beamActivityCycle1 field 804-1 and the beamActivityCycle2 field 804-2 and each of the BeamActivityCycle-Config IEs include a value in the bac-InactivityTimer field 810, then the behavior UE 110 may be represented by example steps in a method, illustrated in FIG. 10, and a time diagram 1100 for a second scheme, illustrated in FIG. 11.

Initially, at a first time instance 1102, the UE 110 may commence a new beam activity cycle. That is, the UE 110 may start monitoring (step 1002) for at least one PDCCH message on the first link using the QCL assumption type configured in the QCL-Info IE (not shown) that is referenced in the qcl-Type1 field 802-1 for a duration given by a value in the bac-onDurationTimer field 808 configured in the BeamActivityCycle-Config IE 806 that is referenced in the beamActivityCycle1 field 804-1. As illustrated in FIG. 11, the first link is a TN link.

At a second time instance 1104, that is, upon determining (step 1004) that the duration given by a value in the bac-onDurationTimer field 808 configured in the BeamActivityCycle-Config IE 806 that is referenced in the beamActivityCycle1 field 804-1 has elapsed, the UE 110 may, optionally, carry out a Beam Inactivity Cycle, in which the UE 110 does not monitor for PDCCH messages. The duration of the Beam Inactivity Cycle may be based on the value in the bac-InactivityTimer field 810. The UE 110 may determine (step 1006) whether a time period, starting from the second time instance 1104, which corresponds to the first OFDM symbol of the first slot following the slot in which the Beam Activity Cycle timer ends, equivalent to the value in the bac-InactivityTimer field 810 has elapsed. Upon determining, at a third time instance 1106, that the value in the bac-InactivityTimer field 810 has elapsed, the UE 110 may start monitoring (step 1008) for at least one PDCCH message on the second link using the QCL assumption type configured in the QCL-Info IE (not shown) that is referenced in the qcl-Type2 field 802-2. The monitoring (step 1008) on the second link, which is illustrated in FIG. 11 as an NTN link, may begin at a fourth time instance 1108 and may continue for a duration given by a value in the bac-onDurationTimer field 808 configured in the BeamActivityCycle-Config IE 806 that is referenced in the beamActivityCycle2 field 804-2. It may be shown that step 1008 accounts for the QCL switching time.

Upon determining (step 1010), at a fifth time instance 1110, that the duration given by the value in the bac-onDurationTimer field 808 configured in the BeamActivityCycle-Config IE 806 that is referenced in the beamActivityCycle2 field 804-2 has elapsed, the UE 110 may, optionally, carry out a Beam Inactivity Cycle, in which the UE 110 does not monitor for PDCCH messages. The duration of the Beam Inactivity Cycle may be based on the value in the bac-InactivityTimer field 810. The UE 110 may stop monitoring (step 1008) for PDCCH messages on the second link, starting from the fifth time instance 1110, which corresponds to the first OFDM symbol of the first slot following the slot in which the Beam Activity Cycle timer ends.

Upon determining (step 1012), at a sixth time instance 1112, that the duration given by the value in the bac-InactivityTimer field 810 configured in the BeamActivityCycle-Config IE 806 that is referenced in the beamActivityCycle2 field 804-2 has elapsed, the UE 110 may then return to monitoring (step 1002) for at least one PDCCH message on the first link using the QCL assumption type configured in the QCL-Info IE (not shown) that is referenced in the qcl-Type1 field 802-1 for a duration equivalent to the value in the bac-InactivityTimer field 810 configured in the BeamActivityCycle-Config IE 806 that is referenced in the beamActivityCycle1 field 804-1. In FIG. 11, the return to monitoring (step 1002) is illustrated as occurring at a sixth time instance 1112, after the QCL switching time.

Aspects of the present application relate to a link activity solution for scenarios wherein there is a loose coordination between terrestrial networks and non-terrestrial networks. The link activity solution may be shown to allow UEs 110 to reduce power consumption and performance by carrying out early QCL switching in a manner that also saves time. Aspects of the link activity solution are based on defining a value for a “Link Activity timer.” Aspects of the link activity solution relate to counting a number of consecutive slots during which a UE 110 monitors for receipt of a PDCCH message on a first link. The PDCCH message may, for example, be related to paging. The PDCCH message may, for another example, be related to system information. The PDCCH message may, for a further example, be related to data reception. When no PDCCH messages have been detected over the course of a duration of time defined by the Link Activity timer, the UE 110 may perform a QCL switching operation to begin monitoring for PDCCH message on a second link.

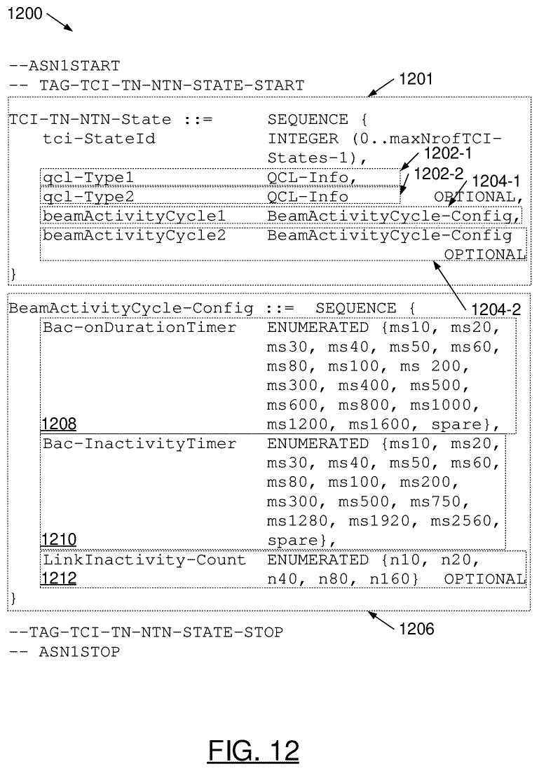

FIG. 12 illustrates an example TN NTN TCI state IE 1200. The example TN NTN TCI state 1200 illustrated in FIG. 12 includes a TN NTN TCI state IE 1201. The TN NTN TCI state IE 1201 includes two QCL-Info fields, denoted as a qcl-Type1 field 1102-1 and a qcl-Type2 field 1202-2, and two BeamActivityCycle-Config fields, denoted as a beamActivityCycle1 field 1204-1 and a beamActivityCycle2 field 1204-2. For the example presented in FIG. 12, it may be assumed that the qcl-Type1 field 1202-1 is associated with the beamActivityCycle1 field 1204-1. This association may be understood to form a QCL relationship for an NTN link. Similarly, it may be assumed that the qcl-Type2 field 1202-2 is associated with the beamActivityCycle2 field 1204-2 and that this association forms a QCL relationship for a TN link.

The example TN NTN TCI state IE 1201 illustrated in FIG. 12 includes a BeamActivityCycle-Config IE 1206 referenced in the beamActivityCycle1 field 1204-1 and in the beamActivityCycle2 field 1204-2. The BeamActivityCycle-Config IE 1206 contains a field denoted as a bac-onDurationTimer field 1208. As discussed hereinbefore, in use, the bac-onDurationTimer field 1208 may be understood to provide a time interval for which an associated QCL assumption type, determined on the basis of a value in the qcl-Type1 field 1202-1, is to be active and is to be used by the UE 110 when monitoring for at least one PDCCH message on the corresponding link (e.g., the NTN link). In the example presented in FIG. 12, the time interval value in the bac-onDurationTimer field 1208 is provided in milli-seconds. However, it should be clear that other units may be considered. Examples of other units available for consideration include OFDM symbols, groups of OFDM symbols, mini-slots, groups of mini-slots, slots, groups of slots, seconds, micro-seconds and nano-seconds. Similarly, the BeamActivityCycle-Config IE 1206 may include a field denoted as bac-InactivityTimer field 1210. The bac-InactivityTimer field 1210 may be understood to provide a time interval for which an associated QCL assumption type, determined on the basis of a value in the qcl-Type1 field 1202-1, is inactive and is not used by the UE 110 to monitor for at least one PDCCH message on the corresponding link (e.g., the NTN link).

The BeamActivityCycle-Config IE 1206 is illustrated, in FIG. 12, as including a linkInactivityCount field 1212. The linkInactivityCount field 1212 may be used to configure a duration for a Link Activity timer. The value in the linkInactivityCount field 1212 may be expressed in a number of slots. Link inactivity is defined as the number of consecutive slots where the UE fails to detect and decode PDCCHs on the associated link using the corresponding QCL assumption.

If the UE 110 is configured with the example TN NTN TCI state IE 1200 of FIG. 12, which includes the beamActivityCycle1 field 1204-1, and if the BeamActivityCycle-Config IE includes a value for a parameter in the bac-onDurationTimer field 1208 and a value for a parameter in the linkInactivityCount field 1212, then the UE 110 may be expected to monitor for at least one PDCCH message on a corresponding link (e.g., the NTN link or the TN link, depending on the QCL relationship) for the duration provided by the value for the parameter in the bac-onDurationTimer field 1208. If the UE 110 fails to detect PDCCH messages for a number of slots greater than the number of slots specified in the linkInactivityCount field 1212, while a timer associated with value for the parameter in the bac-onDurationTimer field 1208 is still running, then the UE 110 may consider the link to have become inactive. Responsively, the UE 110 may stop monitoring for PDCCH messages for the remainder of the value for the parameter in the bac-onDurationTimer field 1208.

Use of a Link Activity timer may be shown to allow the UE 110 to reduce power consumption by discontinuing the monitoring for PDCCH messages on a given active link. Notably, the UE 110, in terms of monitoring for PDCCH messages, need not be limited to only monitoring PDCCH messages that act to schedule future PDSCH transmissions that carry UE-specific data, e.g., PDCCH transmissions carrying a DCI format scrambled with a CRC masked with a Cell Radio Network Temporary Identifier (C-RNTI). More expensively, the monitoring carried out by the UE 110 may include monitoring for PDCCH messages carrying DCI formats scrambled with a CRC masked with a Paging RNTI (also referred to as P-RNTI) or DCI formats scrambled with a CRC masked with a System Information RNTI (also referred to as SI-RNTI).

Notably, other UE RNTIs may be considered when counting the number of received PDCCH messages for the purpose of link inactivity monitoring. The other UE RNTIs may include, e.g., Group RNTI (G-RNTI), Interruption RNTI (INT-RNTI), Modulation Coding Scheme RNTI (MCS-RNTI), Multicast/Broadcast Services Control Channel RNTI (MCCH-RNTI); Paging Early Indication RNTI (PEI-RNTI), Slot Format Indication RNTI (SFI-RNTI), etc.

In aspects of the present application, instead of waiting until the expiry of bac-onDurationTimer, the UE 110 may make an earlier switch a QCL assumption type on a first link to a QCL assumption type on another link. The discussion hereinafter considers three types of RNTIs: P-RNTI; SI-RNTI; and C-RNTI. However, it should be clear that many more types of RNTIs may be considered, including: G-RNTI; INT-RTNI; MCS-RNTI; MCCH-RNTI; PEI-RNTI; SFI-RNTI; etc.

The UE 110 may be configured with a TN NTN TCI state that includes beamActivityCycle1 and with BeamActivityCycle-Config IEs that include a value in the bac-onDurationTimer and a value in the linkInactivityCount field 1202.

In such a case, the UE 110 may start monitoring for at least one PDCCH message on a first link using a QCL assumption type configured in the QCL-Info IE (not shown) that is referenced in the qcl-Type1 field 802-1 for a duration equivalent to the value in the bac-onDurationTimer field 808 configured in the BeamActivityCycle-Config IE (not shown) that is referenced in the beamActivityCycle1 field 804-1. Additionally, the UE 110 may initialize, to 0, a link inactivity counter.

Responsive to the UE 110 having failed to detect, in a first slot, a PDCCH transmission carrying a DCI format scrambled with a CRC masked with an RNTI (say, any one of: P-RNTI; SI-RNTI; and C-RNTI), the UE 110 increments, by 1, the link inactivity counter.

For every consecutive slot in which the UE 110 has failed to detect a PDCCH transmission carrying a DCI format scrambled with a CRC masked with an RNTI (say, any one of: P-RNTI; SI-RNTI; and C-RNTI), the UE 110 may increment, by 1, the link inactivity counter. Otherwise, that is, each time a PDCCH transmission is successfully detected, the UE 110 resets, to 0, the link inactivity counter.

Responsive to the UE 110 having determined that the link inactivity counter has reached, or exceeded, the value configured in the linkInactivityCount field 1202, then the UE 110 may carry out a QCL assumption type switching operation from a QCL assumption type in use on a first link (e.g., an NTN link) to a QCL assumption type on a second link (e.g., a TN link). The switching operation is expected to take a time given as a QCL switching time. Upon completion of the QCL switching time, the UE 110 may start to monitor for at least one PDCCH message on the second link, using the corresponding QCL assumption type.

Up to this point, the discussed aspects of the present application have related to link activity solutions applicable to scenarios wherein there is a loose coordination between terrestrial networks and non-terrestrial networks. Further aspects of the present application relate to solutions applicable to scenarios wherein there is a tight coordination between terrestrial and non-terrestrial systems. These aspects may be shown to be based on using higher-layer signaling to provide a TN NTN TCI state configuration to a UE 110. These aspects may be shown to be based on using dynamic signaling, for example, in the form of a DCI format, to provide a QCL index and a Beam Activity duration. That is, an example DCI format may include a field for the QCL index and a field for the Beam Activity duration.

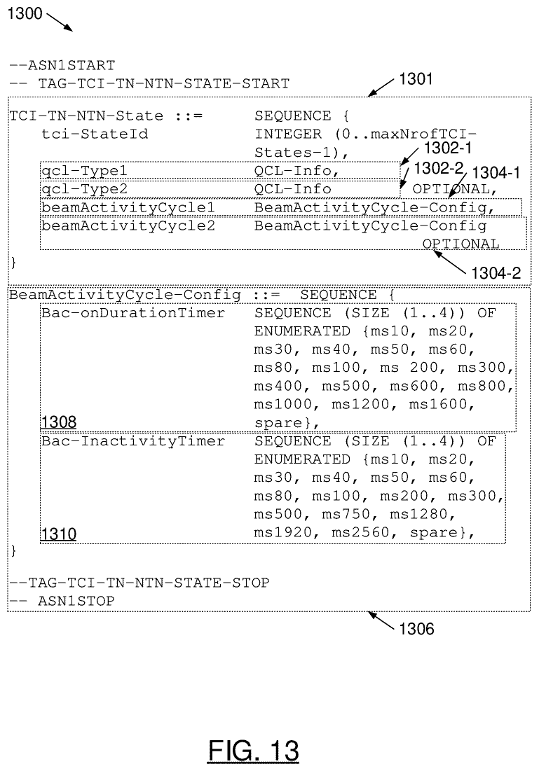

FIG. 13 illustrates an example TN NTN TCI state IE 1300. The example TN NTN TCI state 1300 illustrated in FIG. 13 includes a TN NTN TCI state IE 1301. The TN NTN TCI state IE 1301 includes two QCL-Info fields, denoted as a qcl-Type1 field 1302-1 and a qcl-Type2 field 1302-2, and two BeamActivityCycle-Config fields, denoted as a beamActivityCycle1 field 1304-1 and a beamActivityCycle2 field 1304-2. For the example presented in FIG. 13, it may be assumed that the qcl-Type1 field 1302-1 is associated with the beamActivityCycle1 field 1304-1. This association may be understood to form a QCL relationship for an NTN link. Similarly, it may be assumed that the qcl-Type2 field 1302-2 is associated with the beamActivityCycle2 field 1304-2 and that this association forms a QCL relationship for a TN link.

The example TN NTN TCI state IE 1301 illustrated in FIG. 13 includes a BeamActivityCycle-Config IE 1306 that is referenced in both the beamActivityCycle1 field 1304-1 and in the beamActivityCycle2 field 1304-2.

The BeamActivityCycle-Config IE 1306 is illustrated as containing a field denoted as a bac-onDurationTimer field 1308. As discussed hereinbefore, in use, the bac-onDurationTimer field 1308 may be understood to provide a time interval for which an associated QCL assumption type, configured in the QCL-Info IE (not shown) that is referenced in the qcl-Type1 field 1302-1, is to be active and is to be used by the UE 110 when monitoring for at least one PDCCH message on the corresponding link (e.g., the NTN link). In the example presented in FIG. 13, the time interval value in the bac-onDurationTimer field 1308 is provided in milli-seconds. However, it should be clear that other units may be considered. Examples of other units available for consideration include OFDM symbols, groups of OFDM symbols, mini-slots, groups of mini-slots, slots, groups of slots, seconds, micro-seconds and nano-seconds.

Similarly, the BeamActivityCycle-Config IE 1306 is illustrated as containing a field denoted as bac-InactivityTimer field 1310. The bac-InactivityTimer field 1310 may be understood to provide a time interval for which an associated QCL assumption type, configured in the QCL-Info IE (not shown) that is referenced in the qcl-Type field 1302-1, is inactive and is not used by the UE 110 to monitor for at least one PDCCH message on the corresponding link (e.g., the NTN link).

A key difference to be noticed between the BeamActivityCycle-Config IE 1306 of FIG. 13 and the BeamActivityCycle-Config IE 1206 of FIG. 12 is that, in the BeamActivityCycle-Config 1E 1306 of FIG. 13, the bac-onDurationTimer field 1308 and the bac-InactivityTimer field 1310 may be configured with multiple (e.g., up to four) distinct values.

The bac-onDurationTimer field 1308, of the BeamActivityCycle-Config IE 1306, provides a time interval for which the associated QCL assumption type, configured in the QCL-Info IE (not shown) that is referenced in the qcl-Type1 field 1302-1, is active and may be used, by the UE 110, to monitor for at least one PDCCH message on the corresponding link (e.g., the NTN link). In the present example, the time interval provided as a value in the bac-onDurationTimer field 1308 is expressed in milli-seconds. However, other units can be considered (e.g., OFDM symbols, groups of OFDM symbols, mini-slots, groups of mini-slots, slots, groups of slots, seconds, micro-seconds, nano-seconds).

Similarly, the bac-InactivityTimer field 1310 may be understood to provide a time interval for which an associated QCL assumption type, configured in the QCL-Info IE (not shown) that is referenced in the qcl-Type1 field 1302-1, is inactive and is not used by the UE 110 to monitor for at least one PDCCH message on the corresponding link (e.g., the NTN link). In the present example, a time interval value is not provided in the bac-InactivityTimer field. It follows that an inactivity timer is not used in the present example.

For these aspects of the present application, the TN and the NTN are understood to be tightly coordinated. Accordingly, an assumption may be made that elements of the TN and/or elements of the NTN may dynamically indicate, to the UE 110, a particular QCL assumption type to use for a given link and a duration over which the particular QCL assumption type may be used.

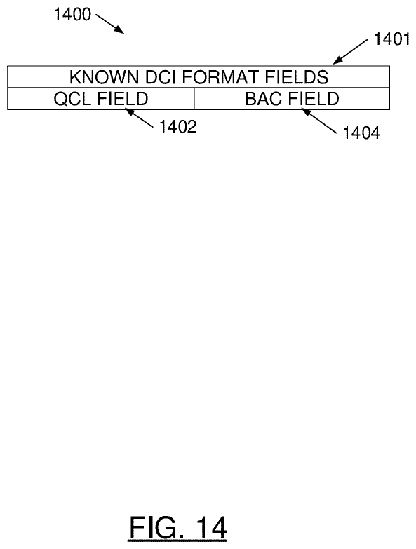

FIG. 14 illustrates an example new DCI format 1400. The example new DCI format 1400 is illustrated as containing a plurality of known fields 1401 and two newly defined fields: a QCL field 1402; and a BAC field 1404. It may be shown that the two newly defined fields 1402, 1404, may be used to dynamically indicate, to the UE 110, a particular QCL assumption type to use in the context of a given TN NTN TCI state and a particular value to use among the plurality of values in the bac-onDurationTimer field 1308.

A TN NTN TCI state IE may have two BeamActivityCycle fields. See, for example, the example TN NTN TCI state IE 1301 illustrated in FIG. 13, which includes the beamActivityCycle1 field 1304-1 and the beamActivityCycle2 field 1304-2. In the example TN NTN TCI state IE 1301 of FIG. 13, both BeamActivityCycle fields 1304-1, 1304-2 reference the same BeamActivityCycle-Config IE 1306. However, it may be understood that each BeamActivityCycle field 1304-1, 1304-2 may reference a distinct BeamActivityCycle-Config IE.

The beamActivityCycle1 field 1304-1 may, for example, reference a first BeamActivityCycle-Config IE (not shown) with two durations in the bac-onDurationTimer field. Recall that the beamActivityCycle1 field 1304-1 may be associated with the QCL assumption type that is configured in the QCL-Info IE (not shown) that is referenced in the qcl-Type field 1302-1. The beamActivityCycle2 field 1304-2 may, for example, reference a second BeamActivityCycle-Config IE (not shown) with four durations in the bac-onDurationTimer field. Recall that the beamActivityCycle2 field 1304-2 may be associated with the QCL assumption type that is configured in the QCL-Info IE (not shown) that is referenced in the qcl-Type2 field 1302-2.

In this example, the QCL field 1402 of the DCI format 1400 may be implemented as a one-bit field to, thereby, allow for specification of a particular QCL assumption type to use among the two QCL assumption types.

In this example, the BAC field 1404 of the DCI format 1400 may be implemented as a two-bit field to, thereby, allow for specification of either one of the two durations in the bac-onDurationTimer field of the first BeamActivityCycle-Config IE (not shown) or one of the four durations in the bac-onDurationTimer field of the second BeamActivityCycle-Config IE (not shown).

The UE 110 may interpret a received value of “0” in the QCL field 1402 as an instruction to use the QCL assumption type that is configured in the QCL-Info IE (not shown) that is referenced in the qcl-Type1 field 1302-1.

The UE 110 may interpret a received value of “00” in the BAC field 1404, in combination with the “0” in the QCL field 1402, as an instruction to use a first one the of the two durations in the bac-onDurationTimer field of the first BeamActivityCycle-Config IE (not shown).

The UE 110 may interpret a received value of “01” in the BAC field 1404, in combination with the “0” in the QCL field 1402, as an instruction to use a second one the of the two durations in the bac-onDurationTimer field of the first BeamActivityCycle-Config IE (not shown).

The UE 110 may interpret a received value of “1” in the QCL field 1402 as an instruction to use the QCL assumption type that is configured in the QCL-Info IE (not shown) that is referenced in the qcl-Type2 field 1302-2.

The UE 110 may interpret a received value of “00” in the BAC field 1404, in combination with the “1” in the QCL field 1402, as an instruction to use a first one the of the four durations in the bac-onDurationTimer field of the second BeamActivityCycle-Config IE (not shown).

The UE 110 may interpret a received value of “01” in the BAC field 1404, in combination with the “1” in the QCL field 1402, as an instruction to use a second one the of the four durations in the bac-onDurationTimer field of the second BeamActivityCycle-Config IE (not shown).

The UE 110 may interpret a received value of “10” in the BAC field 1404, in combination with the “1” in the QCL field 1402, as an instruction to use a third one the of the four durations in the bac-onDurationTimer field of the second BeamActivityCycle-Config IE (not shown).

The UE 110 may interpret a received value of “11” in the BAC field 1404, in combination with the “1” in the QCL field 1402, as an instruction to use a fourth one the of the four durations in the bac-onDurationTimer field of the second BeamActivityCycle-Config IE (not shown).

It may be assumed that the UE 110 is configured with a TN NTN TCI state and, based on that TCI state, the UE 110 may begin by monitoring for at least one PDCCH message on a first link, which may be an NTN link, for a time interval given by a value in the bac-onDurationTimer field of the BeamActivityCycle-Config IE (not shown) referenced in the beamActivityCycle1 field. The UE 110 may, subsequently, monitor for at least one PDCCH message on a second link, which may be a TN link, for a time interval given by a value in the bac-onDurationTimer field of the BeamActivityCycle-Config IE (not shown) referenced in the beamActivityCycle2 field.

The UE 110 first connects to an NT-TRP 172 via the first (NTN) link and monitors for at least one PDCCH message on the first link using the QCL assumption type that is configured in the QCL-Info IE (not shown) that is referenced in the qcl-Type1 field. It is assumed that the QCL-Info IE (not shown) includes a reference to a source reference signal (e.g., GNSS, SS/PBCH block, NZP CSI-RS) and a reference to a QCL assumption type. The reference to the QCL assumption type may be understood to provide the UE 110 with an indication of properties (e.g., Spatial Rx filter, average delay) of the QCL assumption.

Since there are multiple durations configured in the bac-onDurationTimer field of the first BeamActivityCycle-Config IE (not shown) referenced in the beamActivityCycle1 field, it may not be immediately clear to the UE 110 which duration to use when carrying out a first beam activity cycle.

If the UE 110 has not received a PDCCH message carrying a DCI format with the QCL field and the BAC field, discussed hereinbefore with reference to FIG. 14, then the UE 110 may assume the first Beam Activity Cycle is to be carried out for the longest duration value that is configured in the bac-onDurationTimer field of the first BeamActivityCycle-Config IE (not shown) referenced in the beamActivityCycle1 field.

While the first beam activity cycle, for the first link, is still underway, the UE 110 may receive and detect a PDCCH message carrying a DCI format with a QCL field and a BAC field. The value in the QCL field may be set to “1” and the value in the BAC field may be set to “00.” In the context of aspects of the present application, a PDCCH message carrying a DCI format with the QCL field and the BAC field included may be considered to be a “dynamic QCL switching indication.” The configured values may be interpreted to indicate that the UE 110 is to switch from the current QCL assumption type, associated with the NTN link, to the QCL assumption type that is associated with the TN link. It is expected that the QCL assumption type associated with the TN link is provided in the QCL-Info IE (not shown) that is referenced in the qcl-Type2 field of the TN NTN TCI state IE. Responsive to receiving the dynamic QCL switching indication, the UE 110 may commence a second beam activity cycle that includes monitoring for at least one PDCCH message on the TN link using the QCL assumption type provided in the qcl-Type2 field. The UE 110 may carry out the second beam activity cycle associated with the TN link for a duration of 40 ms, based on a value received in the BAC field of the received DCI format.

The UE 110 is expected to carry out a QCL switching operation subsequent to the end of the last OFDM symbol of the PDCCH message carrying the dynamic QCL switching indication.

The UE 110 monitors for at least one PDCCH message on the TN link for a duration of 40 ms, based on a value received in the BAC field of the received DCI format. It may be assumed that no PDCCH messages carrying DCI formats with a dynamic QCL switching indication are received within this 40 ms duration. Upon expiry of the second beam activity cycle duration (40 ms), the UE 110 may carry out another QCL switching operation to switch the QCL assumption type back to the QCL assumption type associated with the NTN link. More specifically, the UE 110 may carry out the QCL switching operation subsequent to the last slot of the second beam activity cycle. Recall that the QCL assumption type associated with the NTN link is configured in the QCL-Info IE (not shown) that is referenced in the qcl-Type1 field. The UE 110 may continue to implement the first beam activity cycle for a period equivalent to the longest duration value that is configured in the bac-onDurationTimer field of the first BeamActivityCycle-Config IE (not shown) referenced in the beamActivityCycle1 field. Recall that the UE 110 will only commence monitoring for PDCCH messages after the expiry of the QCL switching time.

In some embodiments, the UE 110 expects to be provided with a list consisting of one or more TN NTN TCI states through higher-layer signaling (e.g., RRC signaling). This list may be denoted as a higher-layer parameter tnNtnTciStatesToAddModList. The list of TN NTN TCI states may be provided in the PDSCH Configuration IE (which may be denoted as the higher-layer parameter PDSCH-Config). Alternatively, the list of TN NTN TCI states may be provided in the BWP Configuration IE (which may be denoted as the higher-layer parameter BWP-DownlinkCommon or BWP-DownlinkDedicated for BWPs used for downlink operation, and BWP-UplinkCommon or BWP-UplinkDedicated for BWPs used for uplink operation). Alternatively, the list of TN NTN TCI states may be provided in the serving cell configuration IE (which may be denoted as the higher-layer parameter ServingCellConfig). Alternatively, the list of TN NTN TCI states may be provided in an IE that is located within the serving cell configuration IE.

In some embodiments, if the UE 110 is in RRC connected mode, the UE 110 may be configured with the higher-layer parameter tnNtnTciStatesToAddModList, which is a list consisting of up to a specific number, M, of TN NTN TCI state configurations to decode PDSCH transmissions according to a detected PDCCH transmission carrying a DCI format intended for the UE 110 and its given serving cell. The specific number, M, may depend upon a UE capability maxNumberConfiguredTNNTNTCIStatesPerCC, where the UE capability maxNumberConfiguredTNNTNTCIStatesPerCC indicates the maximum number of TN NTN TCI states the UE 110 can be configured with on a per-carrier basis.

In some embodiments, if the UE 110 is in RRC connected mode and the UE 110 receives a higher layer configuration of tnNtnTciStatesToAddModList with more than one TN NTN TCI states, the UE 110 may expect to receive a MAC-CE command indicating an activation of one TN NTN TCI state from among the configured TCI states within tnNtnTciStatesToAddModList and the UE 110 may obtain the QCL assumptions from the configured TN NTN TCI state for the DM-RS of PDSCH and the DM-RS of PDCCH and the CSI-RS applying the indicated TN NTN TCI state.

In some embodiments, if the UE 110 is in RRC connected mode and the UE 110 receives a higher layer configuration of tnNtnTciStatesToAddModList with more than one TN NTN TCI state, the UE 110 may expect to receive a MAC-CE command indicating an activation of one TN NTN TCI state from among the configured TCI states within tnNtnTciStatesToAddModList and the UE 110 may obtain the QCL assumptions from the configured TN NTN TCI state for the DM-RS of PDCCH and the CSI-RS applying the indicated TN NTN TCI state.

In some embodiments, if the UE 110 is in RRC connected mode and the UE 110 receives a higher layer configuration of tnNtnTciStatesToAddModList with more than one TN NTN TCI states, the UE 110 may expect to receive a MAC-CE command indicating an activation of one TN NTN TCI state from among the configured TCI states within tnNtnTciStatesToAddModList and the UE 110 may assume that the downlink receive spatial filter (e.g., the downlink receive beam) for PDSCH, PDCCH and the CSI-RS applying the indicated TN NTN TCI state is the same as the downlink receive spatial filter (e.g., the downlink receive beam) obtained from the indicated TN NTN TCI state.

In some embodiments, if the UE 110 is in RRC connected mode and the UE 110 receives a higher layer configuration of tnNtnTciStatesToAddModList with a single TN NTN TCI state and that single TN NTN TCI state can be used as an indicated TN NTN TCI state, the UE 110 may obtain the QCL assumptions from the configured TN NTN TCI state for the DM-RS of PDSCH and the DM-RS of PDCCH and the CSI-RS applying the indicated TN NTN TCI state.

In some embodiments, if the UE 110 is in RRC connected mode and the UE 110 receives a higher layer configuration of tnNtnTciStatesToAddModList with a single TN NTN TCI state and that single TN NTN TCI state can be used as an indicated TN NTN TCI state, the UE 110 may obtain the QCL assumptions from the configured TN NTN TCI state for the DM-RS of PDCCH and the CSI-RS applying the indicated TN NTN TCI state.

In some embodiments, if the UE 110 is in RRC connected mode and the UE 110 receives a higher layer configuration of tnNtnTciStatesToAddModList with a single TN NTN TCI state and that single TN NTN TCI state can be used as an indicated TN NTN TCI state, the UE 110 may assume that the downlink receive spatial filter (e.g., the downlink receive beam) for PDSCH, PDCCH and the CSI-RS applying the indicated TN NTN TCI state is the same as the downlink receive spatial filter (e.g., the downlink receive beam) obtained from the indicated TN NTN TCI state.

In some embodiments, if the UE 110 is in RRC connected mode, the UE 110 shall be configured with a higher layer configuration of tnNtnTciStatesToAddModList with at least one TN NTN TCI state and the at least one TN NTN TCI state shall be usable as an indicated TN NTN TCI state. The UE 110 shall obtain the QCL assumptions from the configured TN NTN TCI state for the DM-RS of PDSCH and the DM-RS of PDCCH and the CSI-RS applying the indicated TN NTN TCI state.

In some embodiments, if the UE 110 is in RRC connected mode, the UE 110 shall be configured with a higher layer configuration of tnNtnTciStatesToAddModList with at least one TN NTN TCI state and the at least one TN NTN TCI state shall be usable as an indicated TN NTN TCI state. The UE 110 shall obtain the QCL assumptions from the configured TN NTN TCI state for the DM-RS of PDSCH and the DM-RS of PDCCH and the CSI-RS applying the indicated TN NTN TCI state.

In some embodiments, the quasi co-location relationship may be configured by the higher-layer parameter qcl-Type1 for the non-terrestrial link and by the higher-layer parameter qcl-Type2 for the terrestrial link (if configured). In some alternative embodiments, the quasi co-location relationship may be configured by the higher-layer parameter qcl-Type1 for the terrestrial link and by the higher-layer parameter qcl-Type2 for the non-terrestrial link (if configured).

In some embodiments, if the UE 110 is in RRC connected mode and the UE 110 receives a higher layer configuration of tnNtnTciStatesToAddModList with one or more TN NTN TCI states, the UE 110 shall expect to receive a MAC-CE command (which may equivalently referred to as the “MAC-CE activation command” or “activation command”) activating at least one of the TN NTN TCI states. The UE 110 may assume that a ‘Quasi Co-location’ field is present in the DCI format and that the ‘Quasi Co-location’ field indicates a QCL index value. The UE 110 may also assume that a ‘Beam Activity Cycle’ field is present in the DCI format and that the ‘Beam Activity Cycle’ field indicates a beam activity cycle value. The ‘Quasi Co-location’ field may have a bit width of 1 bit, where the first bit indicates one of qcl-Type or qcl-Type2 in the indicated TN NTN TCI state. The ‘Beam Activity Cycle’ field may have a bit width of 1 bit, where the first bit indicates one of at least two configured values configured within the higher-layer parameter bac-onDurationTimer. The bit takes the value of ‘o’ to indicate using a first configured value of bac-onDurationTimer, the bit takes the value of ‘1’ to indicate using a second configured value of bac-onDurationTimer.

In some embodiments, if the UE 110 is in RRC connected mode and the UE 110 receives a higher layer configuration of tnNtnTciStatesToAddModList with one or more TN NTN TCI states, the UE 110 shall expect to receive a MAC-CE command (which may equivalently referred to as the “MAC-CE activation command” or “activation command”) activating at least one of the TN NTN TCI states. The UE 110 may assume that the ‘Quasi Co-location’ field is present in the DCI format and that the ‘Quasi Co-location’ field indicates a QCL index value. The UE 110 may also assume that the ‘Beam Activity Cycle’ field is present in the DCI format and that the ‘Beam Activity Cycle’ field indicates a beam activity cycle value. The ‘Quasi Co-location’ field may have a bit width of 1 bit, where the first bit indicates one of qcl-Type1 or qcl-Type2 in the indicated TN NTN TCI state. The ‘Beam Activity Cycle’ field may have a bit width of 2 bits, where the bits may indicate one of four configured values within the higher-layer parameter bac-onDurationTimer. The bits may take the value of ‘00’ to indicate using a first configured value of bac-onDurationTimer. The bits may take the value of ‘01’ to indicate using a second configured value of bac-onDurationTimer. The bits may take the value of ‘10’ to indicate using a third configured value of bac-onDurationTimer. The bits may take the value of ‘11’ to indicate using a fourth configured value of bac-onDurationTimer.

In some embodiments, if the UE 110 is in RRC connected mode and the UE 110 receives a higher layer configuration of tnNtnTciStatesToAddModList with one or more TN NTN TCI states, the UE 110 shall expect to receive a MAC-CE command (which may equivalently referred to as the “MAC-CE activation command” or “activation command”) activating at least one of the TN NTN TCI states. The UE 110 may assumes that the ‘Quasi Co-location’ field is present in the DCI format and that the ‘Quasi Co-location’ field indicates a QCL index value. The UE 110 may also assume that the ‘Beam Activity Cycle’ field is present in the DCI format and that the ‘Beam Activity Cycle’ field indicates a beam activity cycle value. The UE 110 may also assume that the ‘Beam Inactivity Cycle’ field indicates a beam inactivity cycle value. The ‘Quasi Co-location’ field may have a bit width of 1 bit, where the first bit indicates one of qcl-Type1 or qcl-Type2 in the indicated TN NTN TCI state. The ‘Beam Activity Cycle’ field may have a bit width of 1 bit, where the first bit indicates one of at least two configured values configured within the higher-layer parameter bac-onDurationTimer. The bit may take the value of ‘o’ to indicate using a first configured value of bac-onDurationTimer, the bit may take the value of ‘1’ to indicate using a second configured value of bac-onDurationTimer. The ‘Beam Inactivity Cycle’ field may have a bit width of 1 bit, where the bit indicates one of at least two configured values configured within the higher-layer parameter bac-InactivityTimer. The bit may take the value of ‘o’ to indicate using a first configured value of bac-InactivityTimer, the bit may take the value of ‘1’ to indicate using a second configured value of bac-InactivityTimer.

In some embodiments, if the UE 110 is in RRC connected mode and the UE 110 receives a higher layer configuration of tnNtnTciStatesToAddModList with one or more TN NTN TCI states, the UE 110 shall expect to receive a MAC-CE command (which may equivalently referred to as the “MAC-CE activation command” or “activation command”) activating at least one of the TN NTN TCI states, the UE 110 assumes that the DCI field ‘Quasi Co-location’ field is present in the DCI format and the DCI field ‘Quasi Co-location’ indicates a QCL index value, the UE 110 also assumes that the DCI field ‘Beam Activity Cycle’ field is present in the DCI format and the DCI field ‘Beam Activity Cycle’ indicates a beam activity cycle value, the UE 110 also assumes that the DCI field ‘Beam Inactivity Cycle’ indicates a beam inactivity cycle value. The DCI field ‘Quasi Co-location’ has a bit width of 1 bit, where the first bit indicates one of qcl-Type1 or qcl-Type2 in the indicated TN NTN TCI state. The DCI field ‘Beam Activity Cycle’ has a bit width of 2 bits, where the first and second bits indicate one of four configured values configured within the higher-layer parameter bac-onDurationTimer. The first and second bits take the value of ‘00’ to indicate using the first configured value of bac-onDurationTimer, the first and second bits take the value of ‘01’ to indicate using the second configured value of bac-onDurationTimer, the first and second bits take the value of ‘10’ to indicate using the third configured value of bac-onDurationTimer, the first and second bits take the value of ‘11’ to indicate using the fourth configured value of bac-onDurationTimer. The DCI field ‘Beam Inactivity Cycle’ has a bit width of 2 bits, where the first and second bits indicate one of four configured values configured within the higher-layer parameter bac-InactivityTimer. The first and second bits take the value of ‘00’ to indicate using the first configured value of bac-InactivityTimer, the first and second bits take the value of ‘01’ to indicate using the second configured value of bac-InactivityTimer, the first and second bits take the value of ‘10’ to indicate using the third configured value of bac-InactivityTimer, the first and second bits take the value of ‘11’ to indicate using the fourth configured value of bac-InactivityTimer.

In some embodiments, the UE 110 may receive a higher layer configuration of tnTciStatesToAddModList with one or more TN TCI states and a higher layer configuration of ntnTciStatesToAddModList with one or more NTN TCI states. Each TN TCI state in the tnTciStatesToAddModList may include a ‘ntnTciStateld’ field, which identifies a NTN TCI state in the ntnTciStatesToAddModList. The presence of the ‘ntnTciStateId’ field creates an association between the TN TCI state and the NTN TCI state identified in the ‘ntnTciStateId’ field. Other association mechanisms, which create an association between TN TCI states and NTN TCI states, have been contemplated in order to create TN NTN TCI states.

In some embodiments, the UE 110 may treat receiving a higher layer configuration without tnNtnTciStatesToAddModList as an invalid higher layer configuration.

In some embodiments, instead of the beam activity cycles defined in the disclosed aspects of this application, the UE 110 may receive a message using lower-layer signaling, such as MAC-CE commands or DCI commands, that initiates QCL switching between, e.g., a terrestrial link and, e.g., a non-terrestrial link. The lower-layer signaling message may contain a dedicated field, which serves as the trigger to initiate the QCL switching.

In some embodiments, instead of the beam activity cycles defined in the disclosed aspects of this application, the UE 110 may receive a message using higher-layer signaling, such as an RRC signaling message, that initiates QCL switching between, e.g., a terrestrial link and, e.g., a non-terrestrial link. The higher-layer signaling message may contain a dedicated field, which serves as the trigger to initiate the QCL switching.

In aspects of the present application, the TN NTN TCI state contains parameters for configuring a quasi co-location relationship between one or two downlink reference signals and the DM-RS ports of the PDSCH, the DM-RS ports of PDCCH, the CSI-RS ports of a CSI-RS resource, the SS/PBCH block ports of a SS/PBCH block resource and/or the GNSS-RS ports of a GNSS-RS resource. The one or two downlink reference signals can be a NZP CSI-RS resource, a SS/PBCH block or a GNSS-RS resource. The meaning of the quasi co-location relationship is that any channel property that applies to the source reference signal (e.g., the average delay, the Doppler spread, the propagation delay, the spatial receive filter, the spatial transmit filter, etc.) also applies to the target reference signal.

In aspects of the present application, some or all embodiments can be used together in combination to produce other variants of QCL assumptions in the context of TN/NTN communication systems.

Broadly, the aspects disclosed hereinbefore relate to switching from monitoring, using a first QCL assumption type for at least one PDCCH message on a first link to monitoring, using a second QCL assumption type for at least one PDCCH message on a second link. The switching has been presented in the context of the first link being one of a TN link or an NTN link and the second link being the other of the TN link and the NTN link. It is also contemplated that the first link may be a first TN link and the second link may be a second TN link. It is further contemplated that the first link may be a first NTN link and the second link may be a second NTN link.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, comprising:
monitoring, using a first quasi-colocation (QCL) assumption type, for at least one physical downlink control channel (PDCCH) message on a first link, wherein the first link is one of a terrestrial network (TN) link or a non-terrestrial network (NTN) link; and
responsive to expiry of a duration of time associated with the first QCL assumption type, switching to monitor, using a second QCL assumption type, for at least one PDCCH message on a second link, wherein the second link is another one of the TN link or the NTN link.

2. The method of claim 1, wherein the first QCL assumption type is a QCL assumption type associated with a TN of the TN link and the second QCL assumption type is a QCL assumption type associated with a NTN of the NTN link.

3. The method of claim 1, wherein the first QCL assumption type is a QCL assumption type associated with a NTN of the NTN link and the second QCL assumption type is a QCL assumption type associated with a TN of the TN link.

4. The method of claim 1, wherein the first QCL assumption type comprises a spatial receive filter.

5. The method of claim 1, wherein the first QCL assumption type comprises an average delay.

6. The method of claim 1, further comprising receiving a TN NTN Transmission Configuration Indicator (TCI) state information element (IE), wherein the TN NTN TCI state IE indicates that a first IE indicates the duration of time.

7. The method of claim 1, wherein the duration of time is expressed in:
milli-seconds;
orthogonal frequency-division multiplexing (OFDM) symbols;
groups of OFDM symbols;
mini-slots;
groups of mini-slots;
slots;
groups of slots;
seconds;
micro-seconds; or
nano-seconds.

8. The method of claim 6, wherein the TN NTN TCI state IE indicates that a second IE indicates the first QCL assumption type.

9. The method of claim 6, wherein the TN NTN TCI state IE includes an indication of a further IE that includes an indication of a duration for an inactivity timer that provides a duration for a time interval for which the first QCL assumption type is not used to monitor for PDCCH messages on the first link.

10. The method of claim 1, further comprising receiving downlink control information (DCI) signaling, the DCI signaling indicates the duration of time.

11. The method of claim 1, further comprising receiving radio resource control (RRC) signaling, the RRC signaling including an indication of the duration of time.

12. An apparatus comprising:
at least one memory storing computer-readable instructions; and
at least one processor coupled to the at least one memory, wherein the at least one processor is caused, by executing the computer-readable instructions, to:
monitor, using a first quasi-colocation (QCL) assumption type, for at least one physical downlink control channel (PDCCH) message on a first link, wherein the first link is one of a terrestrial network (TN) link or a non-terrestrial network (NTN) link; and
switch, responsive to expiry of a duration of time associated with the first QCL assumption type, to monitor, using a second QCL assumption type, for at least one PDCCH message on a second link, wherein the second link is another one of the terrestrial network (TN) link or the non-terrestrial network (NTN) link.

13. The apparatus of claim 12, wherein the first QCL assumption type comprises a spatial receive filter.

14. The apparatus of claim 12, wherein when the computer-readable instructions are executed, the apparatus is further caused to: receive a TN NTN Transmission Configuration Indicator (TCI) state information element (IE), wherein the TN NTN TCI state IE indicates that a first IE indicates the duration of time.

15. The apparatus of claim 12, wherein the duration of time is expressed in:
milli-seconds;
orthogonal frequency-division multiplexing (OFDM) symbols;
groups of OFDM symbols;
mini-slots;
groups of mini-slots;
slots;
groups of slots;
seconds;
micro-seconds; or
nano-seconds.

16. The apparatus of claim 14, wherein the TN NTN TCI state IE includes an indication of a further IE that includes an indication of a duration for an inactivity timer that provides a duration for a time interval for which the first QCL assumption type is not used to monitor for PDCCH messages on the first link.

17. The apparatus of claim 12, wherein when the computer-readable instructions are executed, the apparatus is further caused to: receive downlink control information (DCI) signaling, the DCI signaling indicates the duration of time.

18. The apparatus of claim 12, wherein when the computer-readable instructions are executed, the is further caused apparatus to: receive radio resource control (RRC) signaling, the RRC signaling including an indication of the duration of time.

19. A non-transitory computer-readable medium storing instructions, the instructions, when executed by a processor, causing the processor to:
monitor, using a first quasi-colocation (QCL) assumption type, for at least one physical downlink control channel (PDCCH) message on a first link, wherein the first link is one of a terrestrial network (TN) link or a non-terrestrial network (NTN) link; and
switch, responsive to expiry of a duration of time associated with the first QCL assumption type, to monitor, using a second QCL assumption type, for at least one PDCCH message on a second link, wherein the second link is another one of the TN link or the NTN link.

20. The non-transitory computer-readable medium of claim 19, wherein when the computer-readable instructions are executed, the processor is further caused to: receive a IN NIN Transmission Configuration Indicator (TCI) state information element (IE), wherein the TN NTN TCI state IE indicates that a first IE indicates the duration of time.
